(19) United States
(12) Patent Application Publication
(10) Pub. No.: US 2026/0212179 A1
(43) Pub. Date: Jul. 23, 2026

(54) TRAINING DATA GENERATION DEVICE, TRAINING DATA GENERATION METHOD, AND NON-TRANSITORY COMPUTER-READABLE MEDIUM

(71) Applicant: NEC Corporation, Tokyo (JP)

(72) Inventors: Ryoma OBARA, Tokyo (JP); Masafumi OYAMADA, Tokyo (JP)

(73) Assignee: NEC Corporation, Tokyo (JP)

(21) Appl. No.: 19/424,706

(22) Filed: Dec. 18, 2025

(30) Foreign Application Priority Data
Jan. 8, 2025 (JP) 2025-003018

(51) Int. Cl. G06N 3/08; G06N 3/0475

(52) U.S. Cl. CPC G06N 3/08; G06N 3/0475

(57) ABSTRACT

A training data generation device includes at least one processor, in which the at least one processor executes acquisition processing of acquiring data, generation processing of generating an action executable on the data, specification processing of specifying a task that is likely to be achieved by execution of the action using the action generated in the generation processing, and output processing of outputting a pair of the task specified in the specification processing and the action generated in the generation processing as training data used for training of a generative model that generates an action for achieving an input task. This training data further enhances reliable decision making through advanced machine learning techniques.

### INCORPORATION BY REFERENCE

This application is based upon and claims the benefit of priority from Japanese patent application No. 2025-003018, filed on Jan. 8, 2025, the disclosure of which is incorporated herein in its entirety by reference.

### TECHNICAL FIELD

The present disclosure relates to a training data generation device, a training data generation method, and a non-transitory computer-readable medium.

### BACKGROUND ART

A generative model for generating an action for achieving an input task is known. A technique for generating training data for training such a generative model is known. For example, Non-Patent Literature 1 below discloses a self-evolving online curriculum reinforcement learning framework (WebRL: Web Reinforcement Learning) designed to train high-performance Web agents using an open large language model (LLM).

Non-Patent Literature 1: Zehan Qi et. al., “WebRL: Training LLM Web Agents via Self-Evolving Online Curriculum Reinforcement Learning”, 2024

In the technique described in Non-Patent Literature 1, reinforcement learning for optimizing an action while considering the overall influence on a task is performed.

### SUMMARY

However, in the related art, an action for achieving a task cannot be appropriately generated, and as a result, generation of training data may fail.

The present disclosure has been made in view of the above problems, and an exemplary object thereof is to provide a technique capable of increasing generation efficiency of generation processing of training data used for training a generative model, the training data being for a generative model that generates an action for achieving an input task.

A training data generation device according to an example aspect of the present disclosure includes at least one processor, in which the at least one processor executes acquisition processing of acquiring data, generation processing of generating an action executable on the data, specification processing of specifying a task that is likely to be achieved by execution of the action using the action generated in the generation processing, and output processing of outputting a pair of the task specified in the specification processing and the action generated in the generation processing as training data used for training of a generative model that generates an action for achieving an input task.

A training data generation method according to an example aspect of the present disclosure includes acquisition processing of acquiring, by at least one processor, data, generation processing of generating, by the at least one processor, an action executable on the data, specification processing of specifying, by the at least one processor, a task that is likely to be achieved by execution of the action using the action generated in the generation processing, and output processing of outputting, by the at least one processor, a pair of the task specified in the specification processing and the action generated in the generation processing as training data used for training of a generative model that generates an action for achieving an input task.

A non-transitory computer-readable medium according to an example aspect of the present disclosure has recorded therein a training data generation program for causing a computer to function as a training data generation device that generates training data used for training of a generative model that generates an action for achieving an input task, the training data generation program causing the computer to function as an acquisition means for acquiring data, a generation means for generating an action executable on the data, a specification means for specifying a task that is likely to be achieved by execution of the action by using the action generated by the generation means, and an output means for outputting a pair of the task specified by the specification means and the action generated by the generation means as the training data.

According to an example aspect of the present disclosure, it is possible to provide a technique for improving generation efficiency of generation processing of training data of a generative model, the training data being used for training of the generative model and generating an action for achieving an input task.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a training data generation device according to the present disclosure;

FIG. 2 is a flowchart illustrating a flow of a training data generation method according to the present disclosure;

FIG. 3 is a block diagram illustrating a configuration of an information processing device according to the present disclosure;

FIG. 4 is a flowchart illustrating a flow of a training data generation method according to the present disclosure;

FIG. 5 is a diagram illustrating a specific example of training data generation processing according to the present disclosure; and

FIG. 6 is a block diagram illustrating a configuration of a computer that functions as the device according to the present disclosure.

### EXAMPLE EMBODIMENT

Hereinafter, example embodiments of the present disclosure will be exemplified. However, the present disclosure is not limited to the following illustrative example embodiments, and various modifications may be made within the scope described in the claims. For example, example embodiments obtained by appropriately combining techniques (some or all of objects or methods) adopted in the following illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are examples of effects expected in the illustrative example embodiments, and do not define extension of the present disclosure. That is, example embodiments that do not exert the effects mentioned in the following illustrative example embodiments may also fall within the scope of the present disclosure.

### First Illustrative Example Embodiment

A first illustrative example embodiment, which is an example of the example embodiments of the present disclosure, will be described in detail with reference to the drawings. The present illustrative example embodiment is a basic form of each of the illustrative example embodiments to be described below. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in another illustrative example embodiment included in the present disclosure within a range in which no particular technical problem occurs.

### (Configuration of Training Data Generation Device)

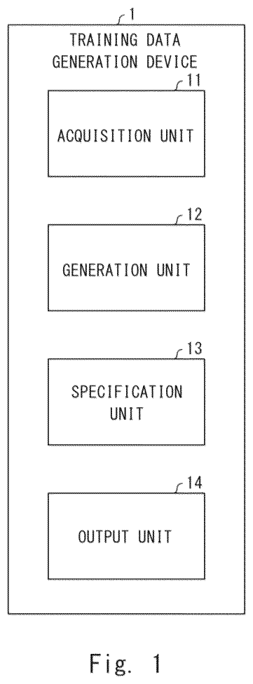

A configuration of a training data generation device 1 will be described with reference to FIG. 1. FIG. 1 is a block diagram illustrating a configuration of the training data generation device 1. As illustrated in FIG. 1, the training data generation device 1 includes an acquisition unit 11, a generation unit 12, a specification unit 13, and an output unit 14.

The acquisition unit 11 acquires data. The generation unit 12 generates an action that can be executed on data. The specification unit 13 specifies a task that is likely to be achieved by execution of the action using the action generated by the generation unit 12. The output unit 14 outputs a pair of the task specified by the specification unit 13 and the action generated by the generation unit 12 as training data used for training of a generative model that generates an action for achieving the input task.

### (Effects of Training Data Generation Device

As described above, the training data generation device 1 employs a configuration including the acquisition unit 11 that acquires data, the generation unit 12 that generates an executable action for the data, the specification unit 13 that specifies a task that is likely to be achieved by execution of the action using the action generated by the generation unit 12, and the output unit 14 that outputs a pair of the task specified by the specification unit 13 and the action generated by the generation unit 12 as training data used for training of a generative model that generates an action for achieving an input task. Therefore, according to the training data generation device 1, it is possible to obtain an effect that the generation efficiency of the generation processing of the training data of the generative model, which is the training data used for the training of the generative model and generates the action for achieving the input task, can be increased.

### (Flow of Training Data Generation Method)

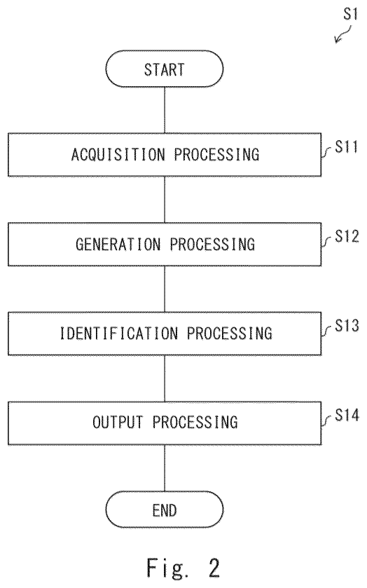

A flow of a training data generation method S1 will be described with reference to FIG. 2. FIG. 2 is a flowchart illustrating a flow of the training data generation method S1. As illustrated in FIG. 2, the training data generation method S1 includes acquisition processing S11, generation processing S12, specification processing S13, and output processing S14.

In the acquisition processing S11, at least one processor acquires data. In the generation processing S12, the at least one processor generates an action that can be executed on the data. In the specification processing S13, the at least one processor specifies a task that is likely to be achieved by execution of the action using the action generated in the generation processing S12. In the output processing S14, the at least one processor outputs a pair of the task specified in the specification processing S13 and the action generated in the generation processing S12 as training data used for training of a generative model that generates an action for achieving the input task.

### (Effect of Training Data Generation Method)

As described above, in the training data generation method S1, a configuration is adopted in which at least one processor includes the acquisition processing S11 of acquiring data, the generation processing S12 of generating an action that can be executed on the data by the at least one processor, the specification processing S13 of specifying a task that is likely to be achieved by execution of the action by the at least one processor using the action generated in the generation processing S12, and the output processing S14 of outputting, by the at least one processor, a pair of the task specified in the specification processing S13 and the action generated in the generation processing S12 as training data used for training of a generative model that generates an action for achieving an input task. Therefore, according to the training data generation method S1, it is possible to increase the generation efficiency of the generation processing of the training data used for training of the generative model that generates the action for achieving the input task.

### [Second Illustrative Example Embodiment]

A second illustrative example embodiment, which is an example of the example embodiments of the present disclosure, will be described in detail with reference to the drawings. Components having the same functions as the components described in the illustrative example embodiment described above are denoted by the same reference numerals, and descriptions thereof will be omitted as appropriate. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technology illustrated in each of the drawings referred to for describing the present illustrative example embodiment can be employed in the other illustrative example embodiments included in the present disclosure within a range in which no particular technical problem occurs.

### (Outline of Information Processing Device)

An information processing device 1A according to the present disclosure generates training data for a generative model that generates an action for achieving an input task. The generative model may be, for example, a large language model (LLM). For example, in a case where a task “Purchase ○○” is given by the user, the generative model generates, as an example, a sequence of actions including an action of accessing a website with a web browser, an action of placing a product in a cart on the website, and an action of clicking a button to purchase the product as the action for achieving the task.

The training data for training the generative model includes a plurality of pairs of tasks and actions capable of achieving the tasks. For example, in a case where the task is the text “Purchase ○○”, the action relevant to the task is, for example, a sequence of actions including an action of accessing a website with a web browser, an action of placing a product in a cart on the website, and an action of clicking a button of purchasing the product.

### (Configuration of Information Processing Device)

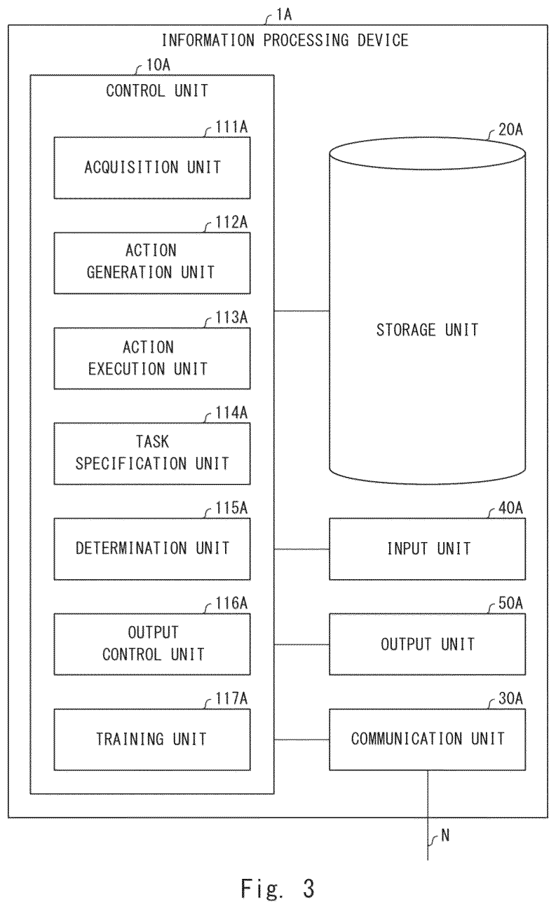

Next, a configuration of the information processing device 1A will be described with reference to FIG. 3. FIG. 3 is a block diagram illustrating a configuration of the information processing device 1A. The information processing device 1A includes a control unit 10A, a storage unit 20A, a communication unit 30A, an input unit 40A, and an output unit 50A.

### (Communication Unit)

The communication unit 30A communicates with a device outside the information processing device 1A via a communication line N. Although the specific configuration of the communication line N is not limited to the present illustrative example embodiment, the communication line N is, for example, a wireless local area network (LAN), a wired LAN, or a wide area network (WAN),
a public network, a mobile data communication network, or a combination thereof. The communication unit 30A transmits data supplied from the control unit 10A to another device, and supplies data received from another device to the control unit 10A.

### (Input Unit)

The input unit 40A is a configuration for receiving an input to the information processing device 1A, and includes, as an example, an input device such as a keyboard, a mouse, a touch panel, a camera, or a microphone. The input unit 40A may be configured to accept data from the input device via, for example, an interface such as a Universal Serial Bus (USB).

### (Output Unit)

The output unit 50A is a configuration for performing output from the information processing device 1A, and includes, as an example, an output device such as a display, a printer, a touch panel, or a speaker. The output unit 50A may include, for example, an interface such as a USB, and may be configured to output data to the output device via the interface.

### (Storage Unit)

The storage unit 20A stores a command of a computer program executed by the control unit 10A. The storage unit 20A stores various pieces of information referred to by the control unit 10A.

### (Control Unit)

As illustrated in FIG. 3, the control unit 10A includes an acquisition unit 111A, an action generation unit 112A, an action execution unit 113A, a task specification unit 114A, a determination unit 115A, an output control unit 116A, and a training unit 117A. The acquisition unit 111A, the action generation unit 112A, the action execution unit 113A, the task specification unit 114A, the determination unit 115A, the output control unit 116A, and the training unit 117A are examples of an acquisition means, a generation means, a specification means, a determination means, an output means, and a training means according to the present disclosure.

### (Acquisition Unit)

The acquisition unit 111A acquires data. The data is data to be subjected to an action. Examples of the data include, but are not limited to, a web page, image data, audio data, moving image data, a pdf file, or a combination thereof.

As an example, the acquisition unit 111A may acquire the data by reading the data from a storage destination (may be a storage device in the information processing device 1A or may be a storage device outside the information processing device 1A) designated by the user of the information processing device 1A. The acquisition unit 111A may acquire data by receiving data from another device via the communication unit 30A. The acquisition unit 111A may acquire the data input to the input unit 40A.

### (Action Generation Unit)

The action generation unit 112A generates an action that can be executed on the data acquired by the acquisition unit 111A. As an example, the action generation unit 112A generates an action using an action generator. The action generator may be a model generated by machine learning, a rule-based model, or a combination thereof, but is not limited thereto. As an example, the action generation unit 112A may randomly select any action from among a plurality of actions that can be executed on the data. The action generation unit 112A may generate one action or may generate a plurality of actions.

### (Action Generator)

In a case where the action generator is generated by machine learning, a machine learning method of the action generator is not limited, and as an example, a decision tree base, a linear regression, or a neural network method may be used, and two or more of these methods may be used. Examples of the decision tree base include Light Gradient Boosting Machine (LightGBM), random forest, and XGBoost. Examples of the linear regression include Bayesian regression, support vector regression, Ridge regression, Lasso regression, and ElasticNet. Examples of the neural network include deep learning.

More specifically, the action generator is, as an example, a generative model generated by machine learning, which includes an artificial neural network having a large number of parameters. Examples of the generative model include, but are not limited to, LLM such as ChatGPT (Chat Generative Pre-trained Transformer), GPT-4 (Generative Pre-trained Transformer 4), or a model in which the LLM is finely tuned by data related to execution of a task.

The action generator may be stored in the storage unit 20A, or may be stored in a device other than the information processing device 1A. The action generator being stored in the storage device means that a parameter that defines the action generator is stored in the storage unit. In a case where the action generator is stored in a device other than the information processing device 1A, the action generation unit 112A transmits input data to the device in which the action generator is stored, and receives output data transmitted from the device as a response to the transmitted input data.

### (Input to Action Generator)

The input data input to the action generator by the action generation unit 112A includes, for example, data (for example, a web page) acquired by the acquisition unit 111A and a prompt for instructing generation of an action. The input data may include, for example, a provisional task set by the user of the information processing device 1A. The provisional task is a task different from the task included in the training data. The input data may include a provisional task and a determination reason as to whether the provisional task is achievable. In this case, the action generation unit 112A can also be said to generate the action using the provisional task, or using the provisional task and the determination reason as to whether the provisional task is achievable. The provisional task and the determination reason as to whether the provisional task is achievable are set by the user of the information processing device 1A, for example.

The input data may include a task specified by the task specification unit 114A to be described later. In this case, the prompt input to the action generator may be, for example, the text “I want to solve [action rationalizer output tasks], please generate appropriate action”. The input data may include a determination reason (why the task cannot be achieved) as to whether the task specified by the task specification unit 114A to be described later can be achieved.

The input data may include an action generated by the action generation unit 112A in the generation processing so far. In this case, the action generation unit 112A can also be said to generate an action using the action sequence generated so far.

### (Output of Action Generator)

The output of the action generator is an action. Also, the output from the action generator may include an explanation of the output (why the action was output).

### (Action Execution Unit)

The action execution unit 113A executes the action generated by the action generation unit 112A. For example, in a case where the data acquired by the acquisition unit 111A is a web page and the action generated by the action generation unit 112A is “Click [beds]”, the action execution unit 113A executes an action of clicking [beds] on the web page. Execution of the action causes transition to a web page different from the web page acquired by the acquisition unit 111A.

### (Task Specification Unit)

The task specification unit 114A specifies a task that is likely to be achieved by execution of the action using the action generated by the action generation unit 112A. As an example, the task specification unit 114A specifies a task using an action rationalizer.

### (Action Rationalizer)

The action rationalizer is a generative model generated by machine learning. In this case, it can be said that the task specification unit 114A specifies a task obtained by inputting the action generated by the action generation unit 112A to the generative model.

The action rationalizer is, as an example, a generative model generated by machine learning, which includes an artificial neural network having a large number of parameters. Examples of the generative model include, but are not limited to, an LLM such as ChatGPT or GPT-4, or an LLM finely tuned with data related to execution of a task. The action generator and the action rationalizer may be the same generative model, or may be different generative models.

The action rationalizer may be stored in the storage unit 20A, or may be stored in a device other than the information processing device 1A. The action rationalizer being stored in the storage unit means that a parameter that defines the action rationalizer is stored in the storage unit. In a case where the action rationalizer is stored in a device other than the information processing device 1A, the task specification unit 114A transmits input data to the device in which the action rationalizer is stored, and receives output data transmitted from the device as a response to the transmitted input data.

### (Input to Action Rationalizer)

The input data input to the action rationalizer by the task specification unit 114A includes, for example, an action or an action sequence generated by the action generation unit 112A. In a case where the input to the action rationalizer is an action sequence, it can be said that the task specification unit 114A specifies a task that is likely to be achieved by execution of the action sequence using the action sequence generated by the action generation unit 112A.

The input data may include description of the action generated by the action generation unit 112A (for what reason the action has been generated). The input data may also include a prompt to instruct generation of the task. The prompt may be, for example, text such as “The output actions of the action generator are as follows. Please consider the tasks that can be achieved by this action.”. The prompt may also include a text that instructs output of a determination reason whether the task is achievable.

The input data may include data acquired by the acquisition unit 111A. The input data may include data after transition that transitions in a case where the action execution unit 113A executes an action. In this case, it can also be said that the task specification unit 114A specifies a task that is likely to be achieved by execution of the action by using data relevant to a state after transition by execution of the action.

### (Output of Action Rationalizer

The output of the action rationalizer includes tasks that are currently desired to be achieved (likely to be achieved). The output of the action rationalizer may also include information indicating whether the input action is capable of accomplishing the task. The output of the action rationalizer may also include a task name. The output of the action rationalizer may also include a determination reason whether the task is achievable (why the task is not achievable).

### (Determination Unit)

The determination unit 115A determines whether the task specified by the task specification unit 114A can be achieved by executing the action generated by the action generation unit 112A. As an example, the determination unit 115A makes a determination based on information indicating whether the task is achievable, which is output from the action rationalizer.

### (Output Control Unit)

The output control unit 116A outputs a pair of the task specified by the task specification unit 114A and the action generated by the action generation unit 112A as training data used for training of a generative model that generates an action for achieving the input task. In other words, it can also be said that the output control unit 116A outputs a task determined to be achievable by the determination unit 115A and an action capable of achieving the task. The output control unit 116A may output a determination reason as to whether the task can be achieved by the determination unit 115A.

The output control unit 116A may write and output the data to a storage destination (a storage device in the information processing device 1A or a storage device outside the information processing device 1A may be used) designated by the user of the information processing device 1A. The output control unit 116A may output the data to an output device such as a display or a printer. The output control unit 116A may output the data by transmitting the data to another device connected via the communication unit 30A.

### (Training Unit)

The training unit 117A trains the generative model using the training data output from the output control unit 116A. As an example, the training unit 117A may fine-tune the generative model using the training data.

### (Flow of Training Data Generation Method)

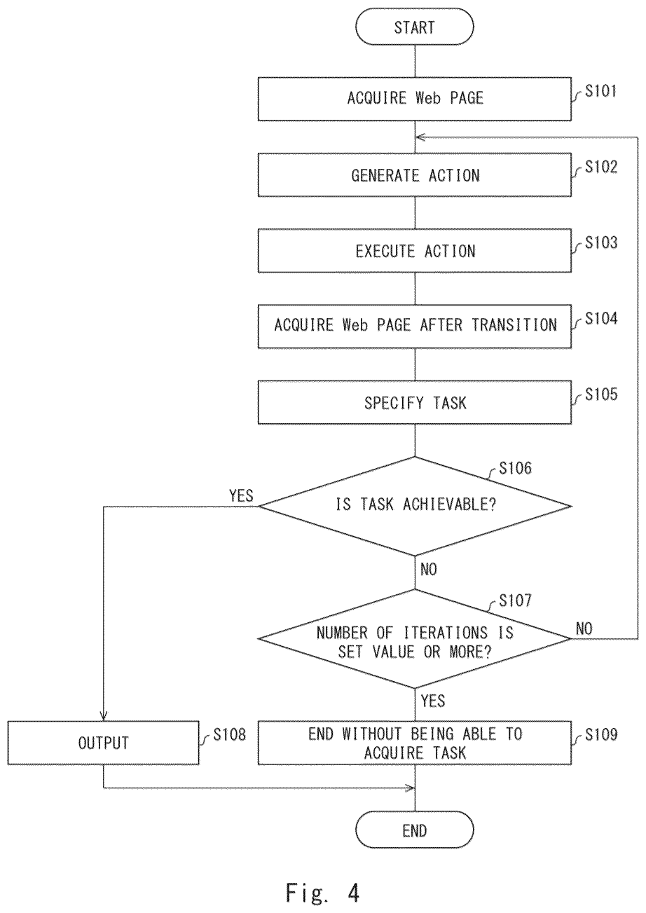

FIG. 4 is a flowchart illustrating a flow of a training data generation method according to the present disclosure. In FIG. 4, an example of generating a pair of an action and a task for a web page will be described. In step S101, the acquisition unit 111A acquires a web page.

In step S102, the action generation unit 112A generates an action that can be executed on the web page. As an example, the action generation unit 112A generates an action by inputting input data including the web page and the prompt acquired by the acquisition unit 111A to the action generator. At this time, the action generation unit 112A may include the provisional task in the input data.

The action generation unit 112A may include the task specified by the task specification unit 114A in the input data to the action generator in the second and subsequent processes of step S102 in a case where the processes of steps S102 to S107 are repeatedly executed. In this case, the prompt may be, for example, the text “I want to solve [action rationalizer output tasks], please generate appropriate action”.

In step S103, the action execution unit 113A executes the action generated by the action generation unit 112A. In a case where the action execution unit 113A executes an action, the web page transitions. In step S104, the task specification unit 114A acquires a Web page after transition that has transitioned due to execution of an action by the action execution unit 113A.

In step S105, the task specification unit 114A specifies a task that is likely to be achieved by execution of the action using the action generated by the action generation unit 112A. As an example, the task specification unit 114A generates a task by inputting input data including an action generated by the action generation unit 112A, a web page after transition, and a prompt for instructing generation of the task to the action rationalizer. The prompt may be, for example, text such as “The output actions of the action generator are as follows. Please reconsider the tasks that can be achieved by this action.”.

In step S106, the determination unit 115A determines whether the task specified by the task specification unit 114A can be achieved by the action generated by the action generation unit 102. As an example, the determination unit 115A makes a determination based on information indicating whether the task is achievable, the information being included in the output of the action rationalizer. In a case where it is determined that the task is achievable (step S106: YES), the determination unit 115A proceeds to the process of step S108. On the other hand, in a case where the determination unit 115A determines that the task is not achievable (step S106: NO), the process proceeds to step S107.

In step S107, the determination unit 115A determines whether the number of iterations of the series of processes in steps S102 to S107 is greater than or equal to a preset set value. In a case where the number of iterations is equal to or larger than the set value (step S107: YES), the determination unit 115A proceeds to the process of step S109. On the other hand, in a case where the number of iterations is less than the set value (step S107: NO), the determination unit 115A returns to the process of step S102.

As illustrated in FIG. 4, the information processing device 1A repeatedly executes the processes of steps S102 to S107 until an achievable task is generated. In the second and subsequent processes of step S102, as an example, the action generation unit 112A inputs input data including the task specified by the task specification unit 114A and the action generated by the action generation unit 112A in the process of step S102 so far to the action generator, thereby executing the processing of generating an action again. In other words, the action generation unit 112A can execute generation of an executable action again using the task determined to be not achievable by the determination unit 115A and the action used by the task specification unit 114A to specify the task. In this manner, the action generator and the action rationalizer exchange information with each other.

In step S108, the output control unit 116A assigns a task name to the task determined to be achievable in step S106, and outputs a pair of the task and the action as training data. At this time, as an example, the output control unit 116A may assign a task name obtained by inputting an action and a prompt for instructing output of the task name to a generative model such as an action rationalizer. In this case, the prompt may be, for example, the text “The output action history of the action generator is as follows. Please give it a task name.”.

In step S109, the output control unit 116A ends the processing without being able to acquire the task. At this time, the output control unit 116A may output a message indicating that the task has not been acquired.

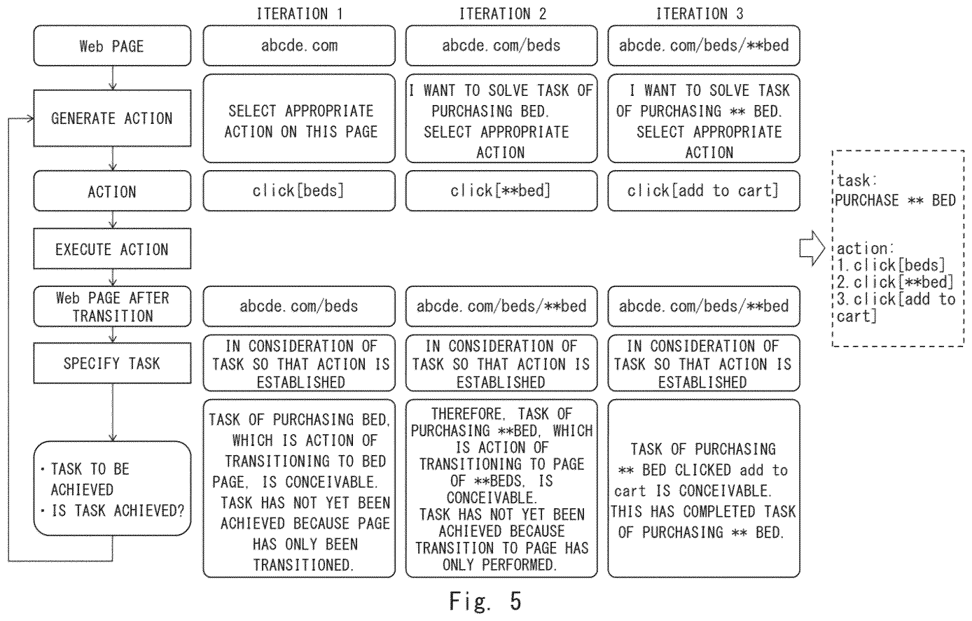

FIG. 5 is a diagram illustrating a specific example of the training data generation processing. In the example of FIG. 5, the information processing device 1A repeatedly executes steps S102 to S107 of FIG. 4 three times. In this example, the data acquired by the acquisition unit 111A is a web page of “abcde.com”.

In the first iteration, the action generation unit 112A inputs input data including a prompt “select an appropriate action on this page” and a web page of “abcde.com” to the action generator. As a result, the action “click [beds]” is output from the action generator. In a case where the action execution unit 113A executes this action, the web page transitions to “abcde.com/beds”.

In the first iteration, the task specification unit 114A inputs input data including a prompt “in consideration of a task so that an action is established”, an action output from the action generator, and a web page after transition to the action rationalizer. From the action rationalizer, a task and a determination reason of task achievement that “a task of purchasing a bed, which is an action of transitioning to the bed page, is conceivable. The task has not been achieved because the page has just transitioned” are output.

In the second iteration, the action generation unit 112A inputs input data including a prompt “I want to solve the task of purchasing a bed. Select the appropriate action” and a web page of “abcde. com/beds” (that is, a web page after transition) to the action generator. This prompt includes a task “purchase a bed” specified by the task specification unit 114A. In a case where this input data is input, the action “click [** bed]” is output from the action generator. In a case where the action execution unit 113A executes this action, the web page transitions to “abcde.com/beds/**bed”.

In the second iteration, the task specification unit 114A inputs input data including a prompt “in consideration of a task so that an action is established”, an action output from the action generator, and a web page after transition to the action rationalizer. The action rationalizer outputs a task and a determination reason of task achievement that “therefore, a task of purchasing the **bed, which is an action of transition to the page of **beds, is conceivable. The task has not been achieved since the page has only been transitioned.”.

In the third iteration, the action generation unit 112A inputs input data including a prompt “I want to solve a task of purchasing a ** bed”. Please select an appropriate action” and a web page of “abcde.com/beds/**bed” (that is, a web page after transition) to the action generator. As a result, the action “click [add to cart]” is output from the action generator. The action execution unit 113A executes this action on the web page.

In the third iteration, the task specification unit 114A inputs input data including a prompt “in consideration of a task so that an action is established”, an action output from the action generator, and a web page of “abcde.com/beds/**bed”. The action rationalizer outputs a task and a determination reason of task achievement that “a task of purchasing a ** bed by clicking add to cart is conceivable. This completed the task of purchasing a ** bed.”.

With the above-described three iterations, training data including a task of “purchasing a **bed” and action sequences of “click [beds]”, “click [**bed]”, and “click [add to cart]” is obtained.

### (Effects of Information Processing Device)

Meanwhile, as a technique for generating training data for training a generative model for generating an action for achieving an input task, for example, there is a technique described in Non-Patent Literature 1. In the technique described in Non-Patent Literature 1, a task is first generated, and an action for solving the task is generated. Therefore, in a case where an appropriate action cannot be generated, generation processing up to that time is wasted, and generation efficiency is degraded. On the other hand, according to the information processing device 1A of the present disclosure, after an action is generated first instead of setting a task first, a process of specifying a task is performed using the generated action. By generating the action before specifying the task in this manner, the success probability of the generation processing of the training data can be increased.

The information processing device 1A employs a configuration in which the determination unit 115A is included which determines whether the task specified by the task specification unit 114A is achievable by executing the action generated by the action generation unit 112A, and the output control unit 116A outputs the task determined to be achievable by the determination unit 115A and the action capable of achieving the task. By outputting the achievable task and action, according to the information processing device 1A, it is possible to obtain an effect that the generation efficiency of the training data generation processing can be increased.

The information processing device 1A employs a configuration in which the output control unit 116A outputs a determination reason as to whether the task is achievable by the determination unit 115A. The user or the like of the information processing device 1A can easily determine whether the generated training data is useful by confirming the determination reason to be output. As a result, for example, more appropriate data can be selected as training data used for training the generative model.

In the information processing device 1A, a configuration is adopted in which the action generation unit 112A executes generation of an executable action again using the task determined to be not achievable by the determination unit 115A and the action used by the task specification unit 114A to specify the task. By repeatedly performing the generation of the action and the specification of the task in this manner, according to the information processing device 1A, it is possible to generate more appropriate data as training data used for training of the generative model.

In the information processing device 1A, a configuration is adopted in which the action generation unit 112A generates the action using a provisional task or using the provisional task and a determination reason as to whether the provisional task is achievable. By using the provisional task and/or the determination reason of the provisional task for generation of the action, the information processing device 1A can generate more appropriate data as training data used for training of the generative model.

In the information processing device 1A, a configuration is adopted in which the task specification unit 114A specifies a task obtained by inputting an action generated by the action generation unit 112A to the generative model. By specifying the task using the generative model, according to the information processing device 1A, the generation efficiency of the generation processing of the training data used for training of the generative model can be increased.

In the information processing device 1A, a configuration is adopted in which the task specification unit 114A specifies a task that is likely to be achieved by execution of the action sequence using the action sequence generated by the action generation unit 112A. By using the action sequence obtained by repeating the action generation processing, according to the information processing device 1A, the generation efficiency of the achievable task generation processing can be increased.

In the information processing device 1A, a configuration is adopted in which the action execution unit 113A is included which executes an action generated by the action generation unit 112A, and the task specification unit 114A specifies a task that is likely to be achieved by execution of the action using data relevant to a state after transition by execution of the action.

In a case where the task is generated using only the data before transition, the generated task may be limited. For example, there may be a case where only an unrealistic task to be completed with one web page is generated, or a case where, for example, even though only three-stage drawers are sold on a web site, a task of “purchase a five-stage drawer” is generated only from data of a web page before transition. On the other hand, in the information processing device 1A, the task to be generated can be prevented from being limited by using the data after transition in addition to the data before transition of the state.

The information processing device 1A employs a configuration including the training unit 117A that trains a generative model using training data. As a result, according to the information processing device 1A, it is possible to train a generative model that generates an action for achieving an input task.

### Exemplary Implementation by Software

Some or all of the functions of the training data generation device and the information processing device 1A (hereinafter, also referred to as “each of the above devices”) may be achieved by hardware such as an integrated circuit (IC chip) or may be achieved by software.

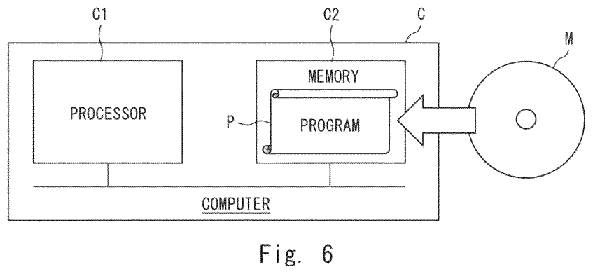

In the latter case, each of the above devices is implemented by, for example, a computer that executes a command of a program as software for implementing each function. An example of such a computer (which will be referred to as a computer C hereinafter) is illustrated in FIG. 6. FIG. 6 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for exchanging data with another device. The computer C may further include an input/output interface for connecting input/output devices such as a keyboard, a mouse, a display, and a printer.

The program P may be recorded in a non-transitory tangible recording medium M readable by the computer C. Examples of such a recording medium M may include a tape, a disk, a card, a semiconductor memory, and a programmable logic circuit. The computer C may obtain the program P via such a recording medium M. The program P may be transmitted via a transmission medium. Examples of such a transmission medium may include a communication network and a broadcast wave. The computer C can also acquire the program P via such a transmission medium.

Each of the above functions of each of the above devices may be implemented by a single processor provided in a single computer, may be implemented by cooperation of a plurality of processors provided in a single computer, or may be implemented by cooperation of a plurality of processors provided in a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information A

The present disclosure includes techniques described in the following Supplementary Notes. However, the present disclosure is not limited to the techniques described in the following Supplementary Notes, and various modifications may be made within the scope described in the claims.

### (Supplementary Note A1)

A training data generation device including:
an acquisition means for acquiring data;
a generation means for generating an action executable on the data;
a specification means for specifying a task that is likely to be achieved by execution of the action using the action generated in the generation means; and
an output means for outputting a pair of the task specified in the specification means and the action generated in the generation means as training data used for training of a generative model that generates an action for achieving an input task.

### (Supplementary Note A2)

The training data generation device according to Supplementary Note A1, further including: a determination means for determining whether the task specified in the specification means is achievable by executing the action generated in the generation means, in which
the output means outputs a task determined to be achievable by the determination means and an action capable of achieving the task.

### (Supplementary Note A3)

The training data generation device according to Supplementary Note A2, in which the output means outputs a determination reason as to whether the task in the determination means is achievable.

### (Supplementary Note A4)

The training data generation device according to Supplementary Note A2 or A3, in which the generation means executes generating of an executable action again by using a task determined not to be achievable by the determination means and an action used for specifying the task in the specification means.

### (Supplementary Note A5)

The training data generation device according to any one of Supplementary Notes A1 to A4, in which the generation means generates the action by using a provisional task or using the provisional task and a determination reason as to whether the provisional task is achievable.

### (Supplementary Note A6)

The training data generation device according to any one of Supplementary Notes A1 to A5, in which the specification means specifies a task obtained by inputting the action generated in the generation means to the generative model.

### (Supplementary Note A7)

The training data generation device according to Supplementary Note A4, in which the specification means specifies a task that is likely to be achieved by execution of the action sequence using an action sequence generated in the generation means.

### (Supplementary Note A8)

The training data generation device according to any one of Supplementary Notes A1 to A7, further including an execution means for executing the action generated in the generation means,
in which the specification means specifies a task that is likely to be achieved by execution of the action by using data relevant to a state after transition by execution of the action.

### (Supplementary Note A9)

The training data generation device according to any one of Supplementary Notes A1 to A8, further including a training means for training the generative model using the training data.

### Supplementary Information B

The present disclosure includes techniques described in the following Supplementary Notes. However, the present disclosure is not limited to the techniques described in the following Supplementary Notes, and various modifications may be made within the scope described in the claims.

### (Supplementary Note B1)

A training data generation method including:
acquisition processing of acquiring, by at least one processor, data;
generation processing of generating, by the at least one processor, an action executable on the data;
specification processing of specifying, by the at least one processor, a task that is likely to be achieved by execution of the action using the action generated in the generation processing; and
output processing of outputting, by the at least one processor, a pair of the task specified in the specification processing and the action generated in the generation processing as training data used for training of a generative model that generates an action for achieving an input task.

### (Supplementary Note B2)

The training data generation method according to Supplementary Note B1, further including determination processing of determining, by the at least one processor, whether the task specified in the specification processing is achievable by executing the action generated in the generation processing,
in which in the output processing, the at least one processor outputs a task determined to be achievable by the determination processing and an action capable of achieving the task.

### (Supplementary Note B3)

The training data generation method according to Supplementary Note B2, in which in the output processing, the at least one processor outputs a determination reason as to whether the task in the determination processing is achievable.

### (Supplementary Note B4)

The training data generation method according to Supplementary Note B2 or B3, in which in the generation processing, the at least one processor executes generating of an executable action again by using a task determined not to be achievable by the determination processing and an action used for specifying the task in the specification processing.

### (Supplementary Note B5)

The training data generation method according to any one of Supplementary Notes B1 to B4, in which in the generation processing, the at least one processor generates the action by using a provisional task or using the provisional task and a determination reason as to whether the provisional task is achievable.

### (Supplementary Note B6)

The training data generation method according to any one of Supplementary Notes B1 to B5, in which in the specification processing, the at least one processor specifies a task obtained by inputting the action generated in the generation processing to the generative model.

### (Supplementary Note B7)

The training data generation method according to Supplementary Note B4, in which in the specification processing, the at least one processor specifies a task that is likely to be achieved by execution of the action sequence using an action sequence generated in the generation processing.

### (Supplementary Note B8)

The training data generation method according to any one of Supplementary Notes B1 to B7, further including execution processing of executing, by the at least one processor, the action generated in the generation processing,
in which in the specification processing, the at least one processor specifies a task that is likely to be achieved by execution of the action by using data relevant to a state after transition by execution of the action.

### (Supplementary Note B9)

The training data generation method according to any one of Supplementary Notes B1 to B8, further including training processing of training, by the at least one processor, the generative model using the training data.

### Supplementary Information C

The present disclosure includes techniques described in the following Supplementary Notes. However, the present disclosure is not limited to the techniques described in the following Supplementary Notes, and various modifications may be made within the scope described in the claims.

### (Supplementary Note C1)

A training data generation program for causing a computer to function as a training data generation device, the program causing the computer to function as:
an acquisition means for acquiring data;
a generation means for generating an action executable on the data;
a specification means for specifying a task that is likely to be achieved by execution of the action using the action generated in the generation means; and
an output means for outputting a pair of the task specified in the specification means and the action generated in the generation means as training data used for training of a generative model that generates an action for achieving an input task.

### (Supplementary Note C2)

The training data generation program according to Supplementary Note C1, the program further causing the computer to function as a determination means for determining whether the task specified in the specification means is achievable by executing the action generated in the generation means, in which
the output means outputs a task determined to be achievable by the determination means and an action capable of achieving the task.

### (Supplementary Note C3)

The training data generation program according to Supplementary Note C2, in which the output means outputs a determination reason as to whether the task in the determination means is achievable.

### (Supplementary Note C4)

The training data generation program according to Supplementary Note C2 or C3, in which the generation means executes generating of an executable action again by using a task determined not to be achievable by the determination means and an action used for specifying the task in the specification means.

### (Supplementary Note C5)

The training data generation program according to any one of Supplementary Notes C1 to C4, in which the generation means generates the action by using a provisional task or using the provisional task and a determination reason as to whether the provisional task is achievable.

### (Supplementary Note C6)

The training data generation program according to any one of Supplementary Notes C1 to C5, in which the specification means specifies a task obtained by inputting the action generated in the generation means to the generative model.

### (Supplementary Note C7)

The training data generation program according to Supplementary Note C4, in which the specification means specifies a task that is likely to be achieved by execution of the action sequence using an action sequence generated in the generation means.

### (Supplementary Note C8)

The training data generation program according to any one of Supplementary Notes C1 to C7, the program further causing the computer to function as an execution means for executing the action generated in the generation means,
in which the specification means specifies a task that is likely to be achieved by execution of the action by using data relevant to a state after transition by execution of the action.

### (Supplementary Note C9)

The training data generation program according to any one of Supplementary Notes C1 to C8, the program further causing the computer to function as a training means for training the generative model using the training data.

### Supplementary Information D

The present disclosure includes techniques described in the following Supplementary Notes. However, the present disclosure is not limited to the techniques described in the following Supplementary Notes, and various modifications may be made within the scope described in the claims.

### (Supplementary Note D1)

A training data generation device comprising at least one processor, in which
the at least one processor is configured to execute:
acquisition processing of acquiring data;
generation processing of generating an action executable on the data;
specification processing of specifying a task that is likely to be achieved by execution of the action using the action generated in the generation processing; and
output processing of outputting a pair of the task specified in the specification processing and the action generated in the generation processing as training data used for training of a generative model that generates an action for achieving an input task.

The training data generation device may further include a memory. The memory may store a program for causing the at least one processor to execute each of the processing.

### (Supplementary Note D2)

The training data generation device according to Supplementary Note D1, in which the at least one processor is further configured to execute:
determination processing of determining whether the task specified in the specification processing is achievable by executing the action generated in the generation processing, and
in the output processing, the at least one processor outputs a task determined to be achievable by the determination processing and an action capable of achieving the task.

### (Supplementary Note D3)

The training data generation device according to Supplementary Note D2, in which in the output processing, the at least one processor outputs a determination reason as to whether the task in the determination processing is achievable.

### (Supplementary Note D4)

The training data generation device according to Supplementary Note D2 or D3, in which in the generation processing, the at least one processor executes generating of an executable action again by using a task determined not to be achievable by the determination processing and an action used for specifying the task in the specification processing.

### (Supplementary Note D5)

The training data generation device according to any one of Supplementary Notes D1 to D4, in which in the generation processing, the at least one processor generates the action by using a provisional task or using the provisional task and a determination reason as to whether the provisional task is achievable.

### (Supplementary Note D6)

The training data generation device according to any one of Supplementary Notes D1 to D5, in which in the specification processing, the at least one processor specifies a task obtained by inputting the action generated in the generation processing to the generative model.

### (Supplementary Note D7)

The training data generation device according to Supplementary Note D4, in which in the specification processing, the at least one processor specifies a task that is likely to be achieved by execution of the action sequence using an action sequence generated in the generation processing.

### (Supplementary Note D8)

The training data generation device according to any one of Supplementary Notes D1 to D7, in which
the at least one processor is further configured to execute execution processing of executing the action generated in the generation processing, and
in the specification processing, the at least one processor specifies a task that is likely to be achieved by execution of the action by using data relevant to a state after transition by execution of the action.

### (Supplementary Note D9)

The training data generation device according to any one of Supplementary Notes D1 to D8, in which the at least one processor is further configured to execute training processing of training the generative model using the training data.

### Supplementary Information E

The present disclosure includes techniques described in the following Supplementary Notes. However, the present disclosure is not limited to the techniques described in the following Supplementary Notes, and various modifications may be made within the scope described in the claims.

### (Supplementary Note E1)

A non-transitory computer-readable medium having recorded therein a training data generation program for causing a computer to function as a training data generation device, the program causing the computer to execute:
acquisition processing of acquiring data;
generation processing of generating an action executable on the data;
specification processing of specifying a task that is likely to be achieved by execution of the action using the action generated in the generation processing; and
output processing of outputting a pair of the task specified in the specification processing and the action generated in the generation processing as training data used for training of a generative model that generates an action for achieving an input task.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A training data generation device comprising at least one processor, wherein
the at least one processor is configured to execute:
acquisition processing of acquiring data;
generation processing of generating an action executable on the data;
specification processing of specifying a task that is likely to be achieved by execution of the action using the action generated in the generation processing; and
output processing of outputting a pair of the task specified in the specification processing and the action generated in the generation processing as training data used for training of a generative model that generates an action for achieving an input task.

2. The training data generation device according to claim 1, wherein
the at least one processor is further configured to execute:
determination processing of determining whether the task specified in the specification processing is achievable by executing the action generated in the generation processing, and
in the output processing, the at least one processor outputs a task determined to be achievable by the determination processing and an action capable of achieving the task.

3. The training data generation device according to claim 2, wherein in the output processing, the at least one processor outputs a determination reason as to whether the task in the determination processing is achievable.

4. The training data generation device according to claim 2, wherein in the generation processing, the at least one processor executes generating of an executable action again by using a task determined not to be achievable by the determination processing and an action used for specifying the task in the specification processing.

5. The training data generation device according to claim 1, wherein in the generation processing, the at least one processor generates the action by using a provisional task or using the provisional task and a determination reason as to whether the provisional task is achievable.

6. The training data generation device according to claim 1, wherein in the specification processing, the at least one processor specifies a task obtained by inputting the action generated in the generation processing to the generative model.

7. The training data generation device according to claim 4, wherein in the specification processing, the at least one processor specifies a task that is likely to be achieved by execution of an action sequence using the action sequence generated in the generation processing.

8. The training data generation device according to claim 1, wherein
the at least one processor is further configured to execute:
execution processing of executing the action generated in the generation processing, and
in the specification processing, the at least one processor specifies a task that is likely to be achieved by execution of the action by using data relevant to a state after transition by execution of the action.

9. The training data generation device according to claim 1, in which the at least one processor is further configured to execute training processing of training the generative model using the training data.

10. A training data generation method comprising:
acquisition processing of acquiring, by at least one processor, data;
generation processing of generating, by the at least one processor, an action executable on the data;
specification processing of specifying, by the at least one processor, a task that is likely to be achieved by execution of the action using the action generated in the generation processing; and
output processing of outputting, by the at least one processor, a pair of the task specified in the specification processing and the action generated in the generation processing as training data used for training of a generative model that generates an action for achieving an input task.

11. A non-transitory computer-readable medium having recorded therein a training data generation program for causing a computer to function as a training data generation device that generates training data used for training of a generative model that generates an action for achieving an input task, the training data generation program causing the computer to function as:
an acquisition means for acquiring data;
a generation means for generating an action executable on the data;
a specification means for specifying a task that is likely to be achieved by execution of the action by using the action generated by the generation means; and
an output means for outputting a pair of the task specified by the specification means and the action generated by the generation means as the training data.
